(19) United States
(12) Patent Application Publication
(10) Pub. No.: US 2012/0057118 A1
(43) Pub. Date: Mar. 8, 2012

(54) LIQUID CRYSTAL DISPLAY DEVICE

(76) Inventors: Katsuhiko Morishita, Osaka (JP); Tsuyoshi Okazaki, Osaka (JP); Takehiko Sakai, Osaka (JP); Dai Chiba, Osaka (JP); Tetsuo Fujita, Osaka (JP); Shingo Kawashima, Osaka (JP)

(21) Appl. No.: 13/321,057

(22) PCT Filed: Apr. 20, 2010
(86) PCT No.: PCT/JP2010/057014

§ 371 Date: Nov. 17, 2011

(30) Foreign Application Priority Data
May 28, 2009 (JP) 2009 129514
Jan. 15, 2010 (JP) 2010 006694

(51) Int. Cl. G02F 1/1343

(52) U.S. Cl. 349/141

(57) ABSTRACT

Provided is a liquid crystal display device in which transmittance can be enhanced. The present invention provides a liquid crystal display device provided with a pair of substrates and a liquid crystal layer sandwiched between the pair of substrates. One of the substrates has a comb-shaped first electrode and a comb-shaped second electrode. The first electrode includes a first trunk portion and a first branch portion obliquely connected to the first trunk portion. The second electrode includes a second trunk portion and a second branch portion obliquely connected to the second trunk portion. The liquid crystal layer includes a p-type nematic liquid crystal that is vertically aligned with respect to the surfaces of the substrates when no voltage is applied. Each pixel has a blank portion of the second electrode having an acute angle-shaped blank portion and an obtuse angle-shaped blank portion that are mutually adjacent. The first branch portion has a specific branch portion disposed within the blank portion of the second electrode. The spacing between the specific branch portion and the second electrode at a portion that extends along the extension direction of the specific branch portion and that forms the acute angle-shaped blank portion is narrower, at least at the tip region of the specific branch portion, than the spacing between the specific branch portion and the second electrode at a portion that extends along the extension direction of the specific branch portion and that forms an obtuse angle-shaped blank portion.

### TECHNICAL FIELD

The present invention relates to a liquid crystal display device. More particularly, the present invention relates to a display device that can be suitably used as a liquid crystal display device of transverse bend alignment (TBA) mode.

### BACKGROUND ART

Liquid crystal display devices are widely used in various fields by virtue of their thin profile, light weight and low power consumption. The display performance of liquid crystal display devices has improved significantly over the years, to the point of surpassing that of CRTs (cathode ray tubes).

The display mode in liquid crystal display devices is determined by the way in which a liquid crystal is arrayed within a cell. Conventional known display modes in liquid crystal display devices include, for instance, TN (Twisted Nematic) mode, MVA (Multi-domain Vertical Alignment) mode, IPS (In-plane Switching) mode, OCB (Optically Self-Compensated Birefringence) mode and the like.

Liquid crystal display devices based on such display modes are mass-produced. For instance, liquid crystal display devices of TN mode are ordinarily widely used among the foregoing modes. Liquid crystal display devices of TN mode, however, have room for improvement in terms of shortcomings such as slow response and narrow viewing angle, among others.

In an MVA mode, by contrast, slits are provided in the pixel electrodes of an active matrix substrate, and protrusions (ribs) for controlling the alignment of liquid crystal molecules are provided in a counter electrode of an opposed substrate, so that, as a result, the alignment direction of the liquid crystal molecules is distributed in a plurality of directions on account of the fringe field formed by the slits and the protrusions. Upon voltage application in an MVA mode, the directions in which the liquid crystal molecules fall is split into a plurality of directions (multi-domain), and a wider viewing angle is achieved as a result. The MVA mode is a vertical alignment mode, and hence characteristically affords higher contrast than TN, IPS or OCB. The MVA mode, however, involves a complex manufacturing process, and like the TN mode, has a slow response, all of which leaves room for improvement.

A display mode (referred to as Transverse Bend Alignment (TEA) mode in the present description) for solving the above process problems of the MVA mode has been proposed wherein a p-type nematic liquid crystal is used as the liquid crystal material, and this liquid crystal is driven by a transverse electric field, using at least two kinds of electrode, such as comb-shaped electrodes or the like, to define thereby the alignment orientation of liquid crystal molecules. The TBA mode allows maintaining high contrast properties through vertical alignment.

For instance, a liquid crystal display device has been described (Patent Document 1) that comprises a liquid crystal material layer injected between a first substrate and a second substrate that face each other, such that the liquid crystal material layer is vertically aligned with respect to the first and second substrates, and wherein the liquid crystal display device comprises at least two electrodes that are parallel to each other and that are formed on one substrate from among the first and second substrates. In this configuration, no alignment control by protrusions is required. Therefore, the pixel configuration is simple and viewing angle characteristics are superior.

Patent Document 1: JP-A-H10-333171

Liquid crystal display devices of TBA mode, however, had room for improvement in terms enhancing transmittance, in particular in types where comb-shaped electrodes are provided in an oblique direction.

More specifically, such types have an acute angle-shaped blank portion (for instance, circled portions in FIG. 19) of an electrode that is formed by a pixel electrode 120 and a counter electrode 130, which are comb-shaped electrodes, as illustrated in FIG. 19. In such acute angle-shaped blank portions of electrodes, the distance between the pixel electrode 120 and the counter electrode 130 is excessively large, and there is generated no sufficient potential difference (transverse electric field) so as to enable transmission of light across the two electrodes. As a result, dark regions occurred in which light failed to be transmitted even during white display.

In an IPS mode that relies on comb-shaped electrodes, as in the TBA mode, the tip portion of the electrodes is ordinarily shielded by a BM, and hence the above problem does not occur in the first place.

### DISCLOSURE OF THE INVENTION

In the light of the above, it is an object of the present invention to provide a liquid crystal display device in which transmittance can be enhanced.

The inventors conducted various studies on liquid crystal display devices where transmittance could be enhanced. Firstly, the inventors considered making the comb-shaped electrodes thicker, so that an electric field could be generated also at the above-described blank portions of the electrodes. However, the inventors found that, in this approach, transmittance decreases as the electrodes become thicker, and there is virtually no contribution to enhancing the overall transmittance of the pixels.

As a result of further research, the inventors found that it was possible to generate sufficient potential difference (for instance, transverse electric field) to allow light to be transmitted also at acute angle-shaped blank portions (opening portions) of an electrode formed by a second electrode, without increasing the thickness of a first electrode, by way of a configuration wherein: a comb-shaped first electrode and a comb-shaped second electrode have each a trunk portion, and a branch portion that is connected to the trunk portion and that intersects obliquely the trunk portion; each pixel has a second electrode blank portion that comprises an acute angle-shaped blank portion and an obtuse angle-shaped blank portion that are mutually adjacent; a branch portion of the first electrode comprises a specific branch portion disposed within the second electrode blank portion; and an acute angle-side spacing, being a spacing between the specific branch portion and the second electrode at a portion along an extension direction of the specific branch portion and that forms the acute angle-shaped blank portion, is set to be narrower, at least at the tip region of the specific branch portion, than an obtuse angle-side spacing, being a spacing between the specific branch portion and the second electrode at a portion along the extension direction of specific branch portion and that forms the obtuse angle-shaped blank portion. The inventors found that the above problems could be admirably solved thereby, and arrived thus at the present invention.

Specifically, the present invention provides a liquid crystal display device provided with a first substrate and a second substrate disposed opposing each other, and a liquid crystal layer sandwiched between the first substrate and the second substrate, wherein the first substrate has a comb-shaped first electrode and a comb-shaped second electrode; the first electrode and the second electrode are disposed opposing each other planarly within a pixel; the first electrode includes a first trunk portion, and a first branch portion that is connected to the first trunk portion and that intersects obliquely the first trunk portion; the second electrode includes a second trunk portion, and a second branch portion that is connected to the second trunk portion and that intersects obliquely the second trunk portion; the liquid crystal layer comprises a p-type nematic liquid crystal and is driven by an electric field generated between the first electrode and the second electrode; the p-type nematic liquid crystal is vertically aligned with respect to surfaces of the first substrate and of the second substrate when no voltage is applied; the pixel has a blank portion of the second electrode including an acute angle-shaped blank portion and an obtuse angle-shaped blank portion that are mutually adjacent, in a plan view of the surfaces of the first substrate and the second substrate; the first branch portion includes a specific branch portion disposed within the blank portion of the second electrode, and wherein an acute angle-side spacing, which is a spacing, between the specific branch portion and a portion of the second electrode that extends along an extension direction of the specific branch portion and that forms the acute angle-shaped blank portion, is narrower, at least at a tip region of the specific branch portion, than an obtuse angle-side spacing, which is a spacing between the specific branch portion and a portion of the second electrode that extends along the extension direction of the specific branch portion and that forms the obtuse angle-shaped blank portion.

Herein, the feature “vertically aligned” does not mandate a pretilt angle of strictly 90°, and indicates that the p-type nematic liquid crystal need only be sufficiently aligned, when no voltage is applied, so as to enable the liquid crystal display device of the present invention to function as a liquid crystal display device of TBA mode.

More specifically, the acute angle-side spacing and the obtuse angle-side spacing denote spacing in a direction perpendicular to the extension direction of the specific branch portion.

The configuration of the liquid crystal display device of the present invention is not especially limited as long as it essentially includes such components.

Preferable embodiments of the liquid crystal display device of the present invention are mentioned in more detail below. The following embodiments may be employed in combination.

The acute angle-side spacing and the obtuse angle-side spacing may be constant from the tip region of the specific branch portion to a root portion of the specific branch portion, or may change stepwise from the tip region of the specific branch portion to a root portion of the specific branch portion. In either case, it becomes possible to effectively form, within one pixel (or subpixel) a plurality of regions at which the spacings between the first electrode and the second electrode are mutually dissimilar. A floating white phenomenon can be suppressed as a result.

The specific branch portion may be linear shaped, or may be bent. In the former case, pixel design can be made easier. In the latter case, it becomes possible to set the acute angle-side spacing to be narrower than the obtuse angle-side spacing at least at the tip region of the specific branch portion, as described above, even in a case where designing a linear-shaped specific branch portion is difficult for reasons of pixel size.

Preferably, the specific branch portion has a constant width. As a result, the specific branch portion need not be made partially thick at the acute angle-shaped blank portion, and hence transmittance can be further enhanced.

Preferably, the acute angle-shaped blank portion and the obtuse angle-shaped blank portion are a first acute angle-shaped blank portion and a first obtuse angle-shaped blank portion, respectively; the specific branch portion is a first specific branch portion; the acute angle-side spacing and the obtuse angle-side spacing are a first acute angle-side spacing and a first obtuse angle-side spacing, respectively; the pixel has a blank portion of the first electrode including a second acute angle-shaped blank portion and a second obtuse angle-shaped blank portion that are mutually adjacent in a plan view of the surfaces of the first substrate and the second substrate; the second branch portion includes a second specific branch portion disposed within the blank portion of the first electrode; and a second acute angle-side spacing, which is a spacing between the second specific branch portion and a portion of the first electrode that extends along an extension direction of the second specific branch portion and that forms the second acute angle-shaped blank portion is narrower, at least at a tip region of the second specific branch portion, than a second obtuse angle-side spacing, which is a spacing between the second specific branch portion and a portion of the first electrode that extends along the extension direction of the second specific branch portion and that forms the second obtuse angle-shaped blank portion. As a result, it becomes possible to generate sufficient potential difference (for instance, transverse electric field) to allow light to be transmitted also at an acute angle-shaped blank portion (opening portion) formed by the first electrode, without increasing the thickness of the second electrode. Accordingly, transmittance can be further enhanced.

More specifically, the second acute angle-side spacing and the second obtuse angle-side spacing denote spacing in a direction perpendicular to the extension direction of the second specific branch portion.

The second acute angle-side spacing and the second obtuse angle-side spacing may be constant from the tip region of the second specific branch portion to a root portion of the second specific branch portion, or may change stepwise from the tip region of the second specific branch portion to a root portion of the second specific branch portion. In either case, it becomes possible to effectively form, within one pixel (or subpixel), a plurality of regions at which the spacings between the first electrode and the second electrode are mutually dissimilar. The floating white phenomenon can be suppressed as a result.

The second specific branch portion may be linear shaped, or may be bent. In the former case, pixel design can be made easier. In the latter case, it becomes possible to set the second acute angle-side spacing to be narrower than the second obtuse angle-side spacing at least at the tip region of the second specific branch portion, as described above, even in a case where designing a linear-shaped second specific branch portion is difficult for reasons of pixel size.

Preferably, the second specific branch portion has a constant width. As a result, the second specific branch portion need not be. made partially thick at the second acute angle-shaped blank portion, and hence transmittance can be further enhanced.

Preferably, the first trunk portion comprises a portion along a top-down direction or left-right direction. Preferably, the second trunk portion comprises a portion along a top-down direction or left-right direction. The above configuration is suitable for liquid crystal display devices in which the axial directions of polarizers are set in a top-down direction and left-right direction.

The first substrate may have a gate bus line bent in the form of a V within a display area, and may have a source bus line bent in the form of a V within a display area. As a result, it becomes possible to suppress drops in transmittance through alignment of the liquid crystal molecules in the axial direction of the polarizers, and transmittance can be further enhanced.

Preferably, the liquid crystal display device has, within the pixel, two regions having mutually dissimilar electrode spacings, which are spacings between the first electrode and the second electrode, and a ratio (surface area of a region of narrower electrode spacing, from among the two regions):(surface area of a region of wider electrode spacing, from among the two regions) ranges from 1:1 to 1:3. This allows suppressing the floating white phenomenon yet more effectively.

The term “constant” encompasses “substantially constant”.

The liquid crystal display device may be a color liquid crystal display device, and the pixel may be a subpixel. In this case, it becomes possible to suppress also color tone changes, along with the floating white phenomenon.

### EFFECT OF THE INVENTION

Transmittance can be enhanced in the liquid crystal display device of the present invention.

### BRIEF DESCRIPTION OF THE DRAWINGS

FIG. 1 is a plan-view schematic diagram illustrating the configuration of a liquid crystal display device of Embodiment 1;

FIG. 2 is a cross-sectional schematic diagram, illustrating the configuration of the liquid crystal display device of Embodiment 1, in which there is depicted an alignment distribution of a liquid crystal during voltage application;

FIG. 3 is a plan-view schematic diagram illustrating the configuration of the liquid crystal display device of Embodiment 1, in particular in the vicinity of a specific pixel branch portion;

FIG. 4 is a plan-view schematic diagram illustrating the configuration of the liquid crystal display device of Embodiment 1, in particular in the vicinity of a specific common branch portion;

FIG. 5 is a plan-view schematic diagram illustrating the configuration of the liquid crystal display device of Embodiment 1;

FIG. 6 is a plan-view schematic diagram illustrating the configuration of the liquid crystal display device of Embodiment 1, in particular in the vicinity of a specific pixel branch portion or a specific common branch portion;

FIG. 7 is a graph illustrating a floating white characteristic of the liquid crystal display device of Embodiment 1;

FIG. 8 is a graph illustrating a floating white characteristic of the liquid crystal display device of Embodiment 1;

FIG. 9 is a graph illustrating a floating white characteristic of the liquid crystal display device of Embodiment 1;

FIG. 10 is a graph illustrating a floating white characteristic of the liquid crystal display device of Embodiment 1;

FIG. 11 is a graph illustrating a floating white characteristic of the liquid crystal display device of Embodiment 1;

FIG. 12 is a graph illustrating a floating white characteristic of the liquid crystal display device of Embodiment 1;

FIG. 13 is a diagram illustrating results of an optical simulation (alignment simulation) of the liquid crystal display device of Embodiment 1;

FIG. 14 is a diagram illustrating results of an optical simulation (alignment simulation) of the liquid crystal display device of Embodiment 1;

FIG. 15 is a diagram illustrating results of an optical simulation (alignment simulation) of the liquid crystal display device of Embodiment 1;

FIG. 16 is a plan-view schematic diagram illustrating the configuration of the liquid crystal display device of Embodiment 1;

FIG. 17 is a plan-view schematic diagram illustrating the configuration of a liquid crystal display device of Embodiment 2;

FIG. 18 is a plan-view schematic diagram illustrating the configuration of the liquid crystal display device of Embodiment 2;

FIG. 19 is a plan-view schematic diagram illustrating the configuration of a liquid crystal display device in a comparative embodiment; and

FIG. 20 is a cross-sectional schematic diagram illustrating the configuration of a liquid crystal display device of Embodiment 3.

### MODE FOR CARRYING OUT THE INVENTION

The present invention will be mentioned in more detail referring to the drawings in the following embodiments, but is not limited to these embodiments.

In the embodiments below, the 3 o'clock direction, the 12 o'clock direction, the 9 o'clock direction and the 6 o'clock direction denote respectively a 0° direction (orientation), a 90° direction (orientation), a 180° direction (orientation) and a 270° direction (orientation); while the direction running through 3 o'clock and 9 o'clock is a left-right direction and the direction running through 12 o'clock to 6 o'clock is a top-down direction, in a front view of the liquid crystal display device, i.e. in a plan view of surfaces of the active matrix substrate and the opposed substrate.

Although in the drawings there are depicted one subpixel or several subpixels alone, actually a plurality of subpixels is provided, in the form of a matrix, in a display area (image display region) of the liquid crystal display device in each embodiment.

Embodiment 1

The liquid crystal display device of the present embodiment is a liquid crystal display device that relies on a so-called TBA mode, from among liquid crystal display devices of transverse electric field mode in which image display is performed by controlling the alignment of a liquid crystal through the action of an electric field (transverse electric field) onto a liquid crystal layer, in the substrate surface direction (direction parallel to the substrate surface).

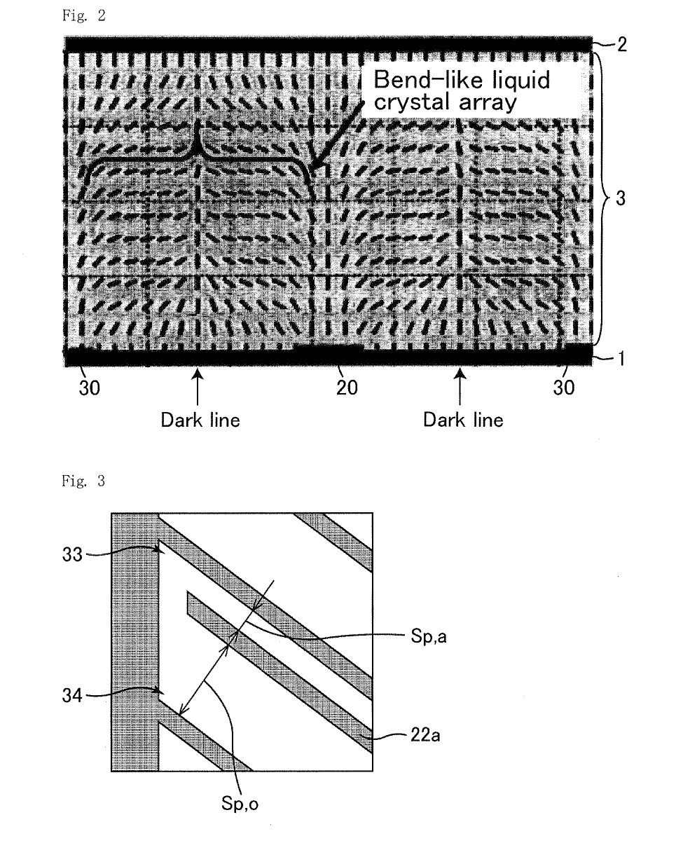

The liquid crystal display device of the present embodiment comprises a liquid crystal display panel. As illustrated in FIG. 2, the liquid crystal display panel has a pair formed of an active matrix substrate (TFT array substrate) 1 and an opposed substrate 2, which are disposed opposing each other, and a liquid crystal layer 3 sandwiched therebetween.

The active matrix substrate 1 corresponds to the first substrate and the opposed substrate 2 corresponds to the second substrate.

A pair of linear polarizers is provided on the outer main surface (side opposite to that of the liquid crystal layer 3) of the active matrix substrate 1 and the opposed substrate 2. The pair of linear polarizers is arranged in a cross-nicol configuration. The absorption axis of one linear polarizer in the pair thereof is disposed in the top-down direction, and the absorption axis of the other linear polarizer is disposed in the left-right direction. As a result, this allows bringing out a superior contrast ratio in the horizontal and the vertical directions. This is particularly preferable in a case where the present embodiment is used in a large-size liquid crystal display device (for instance a television set).

The active matrix substrate 1 and the opposed substrate 2 are bonded by way of a sealing agent that is provided so as to surround the display area, via a spacer such as plastic beads or the like. A liquid crystal layer 3 is formed, by sealing a liquid crystal material, as a display medium that makes up an optical modulation layer, in the gap between the active matrix substrate 1 and the opposed substrate 2.

The liquid crystal layer 3 comprises a nematic liquid crystal material (p-type nematic liquid crystal material) having positive dielectric anisotropy. When no voltage is applied (i.e. when no electric field is generated by a pixel electrode and a common electrode), the liquid crystal molecules of the p-type nematic liquid crystal material exhibit a homeotropic alignment on account of the alignment restricting force of vertical alignment films that are provided of the surface of the active matrix substrate 1 and of the opposed substrate 2, on the liquid crystal layer 3 side. When no voltage is applied, more specifically, the major axis of the liquid crystal molecules of the p-type nematic liquid crystal material in the vicinity of the vertical alignment films forms an angle of 88° or greater (more preferably 89° or greater) with respect to the the active matrix substrate 1 and the opposed substrate 2.

Thus, the liquid crystal display panel of the present embodiment has a pair of polarizers disposed in a cross-nicol configuration, and a liquid crystal layer 3 of 1.0 vertical alignment type. Accordingly, the liquid crystal display panel of the present embodiment is of normally-black type.

The panel retardation dΔn (product of the cell gap d and the birefringence Δn of the liquid crystal material) ranges preferably from 275 to 460 nm, more preferably from 280 to 400 nm. On account of mode relationships, the lower limit of dΔn is preferably equal to or greater than the half wavelength of green at 550 nm, and the upper limit of dΔn lies preferably within a range that allows compensation by the retardation Rth in the normal direction of a negative C-plate single layer. The negative C plate is provided for the purpose of compensating color tone changes and floating white that may occur upon viewing from an oblique direction during black display. A stack of negative C plates can conceivably afford greater Rth, but at a higher cost.

The dielectric constant Δε of the liquid crystal material ranges preferably from 10 to 25, more preferably form 15 to 25. The lower limit of Δε is preferably about 10 or greater (more preferably, 15 or greater), since white voltage (voltage during white display) involves a higher voltage. A greater Δε enables a lower voltage, which is preferable. The upper limit of Δε is set at 25 at most, assuming that materials easily available at present are used herein.

The opposed substrate 2 has: a black matrix (BM) layer that shields light in the space between subpixels, on one of the main surfaces (on the liquid crystal layer 3 side) of a colorless transparent insulating substrate; a plurality of colored layers (color filters) provided for each respective subpixel; and a vertical alignment film provided on the surface, on the liquid crystal layer 3 side, that covers the foregoing build-up. The BM layer is formed, for instance, out of a non-transparent metal such as Cr, or out of a non-transparent organic film, for instance an acrylic resin containing carbon. The BM layer is formed at a region corresponding to the boundary region of adjacent subpixels. The colored layers are used for performing color display. The colored layers are formed on out, for instance, an organic film or the like, for instance of an acrylic resin containing a pigment. Each colored layer is formed mainly at the subpixel region.

The liquid crystal display device of the present embodiment is a color liquid crystal display device provided with a colored layer on an opposed substrate 2 (active matrix-type liquid crystal display device for color display), such that each pixel is made up of three subpixels that output light of a respective color, namely R (red), G (green) and (B) blue. The color and number of subpixels that make up each pixel is not particularly limited, and can be appropriately set. In the liquid crystal display device of the present embodiment, for instance, each pixel may be made up of three subpixels, cyan, magenta and yellow, but may be made up of subpixels of four or more colors.

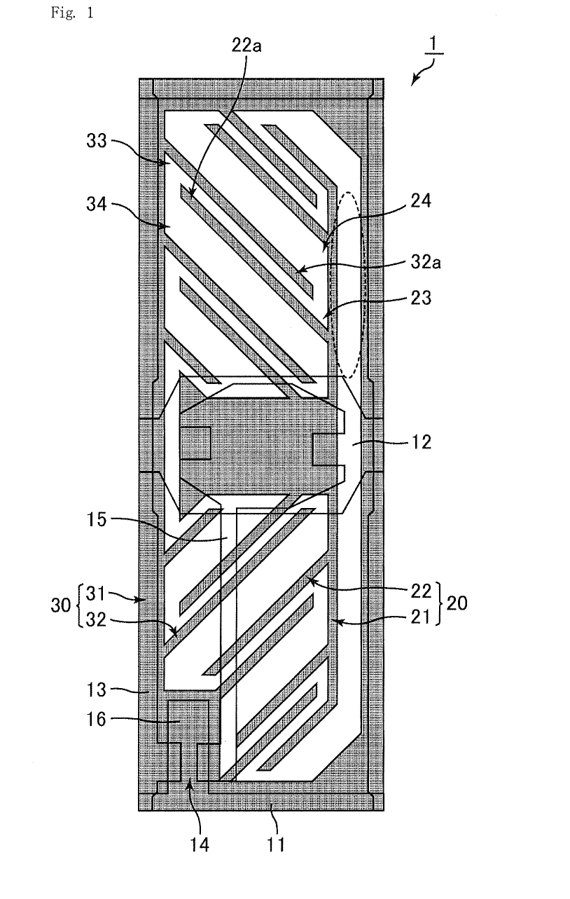

As illustrated in FIG. 1, the active matrix substrate 1 has: a colorless transparent insulating substrate, and on a main surface of the latter (on the liquid crystal layer 3 side), a gate bus line 11; a Cs bus line 12; a source bus line 13; a thin film transistor (TFT) 14, as a switching element, such that one TFT is provided for each subpixel; drain wiring (drain) 15 connected to each TFT 14; a pixel electrode (drain electrode) 20 provided individually for each respective subpixel; a common electrode 30 shared by the subpixels; and a vertical alignment film provided on the surface, on the liquid crystal layer 3 side and that covers the foregoing build-up.

The vertical alignment films provided on the active matrix substrate 1 and the opposed substrate 2 are formed through coating of a known alignment film material such as polyimide. Ordinarily, the vertical alignment films are not subjected to a rubbing process, such that the vertical alignment films can align the liquid crystal molecules substantially vertically with respect to the film surface, when no voltage is applied.

The pixel electrode 20 provided for each subpixel, as well as the common electrode 30 formed contiguously (integrally) with all adjacent subpixels, are provided on the main surface, on the liquid crystal layer 3 side, of the active matrix substrate 1.

The pixel electrodes 20 correspond to one from among the first electrode and the second electrode, and the common electrode 30 corresponds to the other from among the first electrode and the second electrode.

An image signal is supplied to each pixel electrode 20 by way of the source bus line 13 (for instance, 2 to 10 μm wide), via the TFT 14. The source bus line 13 extends in the top-down direction between adjacent subpixels. Each pixel electrode 20 is electrically connected to the drain wiring 15 of the TFT 14, by way of a contact hole that is provided in an interlayer dielectric. A common signal shared by the subpixels is supplied to the common electrode 30. The common electrode 30 is connected to a common voltage generating circuit, and is set to a predetermined potential (for instance, 0 V).

The source bus line 13 is connected to the source driver (data line driving circuit). The gate bus line 11 (having a width of, for instance, 2 to 15 μm), extends in the left-right direction between adjacent subpixels. The gate bus line 11 is connected to a gate driver (scanning line driving circuit) outside the display area. The gate bus line 11 is connected to the gate 16 of the TFT 14 by being formed contiguously (integrally) with the gate 16. Scan signals supplied in pulses by the gate driver to the gate bus line 11 at predetermined timings are line-sequentially applied to each TFT 14. An image signal supplied by the source bus line 13 is applied, at a predetermined timing, to the pixel electrode 20 that is connected to the TFT 14 having been brought to an on-state for a given period of time through the input of a scan signal. Image signals are written thereby into the liquid crystal layer 3.

An image signal of a predetermined level written in the liquid crystal layer 3 is held for a given time interval between the pixel electrode 20 to which an image signal is applied, and the common electrode 30 that opposes the pixel electrode 20. That is, a capacitance (liquid crystal capacitance) is formed, for a given time interval between the electrodes 20 and 30. Storage capacitance is formed in parallel to the liquid crystal capacitance, in order to avoid leaks in the image signal that is held. A storage capacitance is formed, in each subpixel, between the drain wiring 15 of the TFT, and the Cs bus line 12 (capacitance hold wiring having a width of, for instance, 2 to 15 μm) that is provided parallelly to the gate bus line 11.

Each pixel electrode 20 is formed out of a transparent conductive film of ITO or the like, or a metal film such as aluminum, chromium or the like. The pixel electrode 20 has a comb shape, in a plan view of the liquid crystal display panel. More specifically, the pixel electrode 20 has a pixel trunk portion 21 being a portion (trunk portion) having a T-shape portion in a plan view, and provided in the top-down direction and the 180° direction, in such a way so as bisect, in a top and bottom half, a subpixel region having a rectangular shape in a plan view; and pixel branch portions 22 (branch portion, comb teeth) connected to the pixel trunk portion 21 and that have a linear shape in a plan view and are provided in a 135° or 225° direction. The pixel trunk portion 21 and the pixel branch portions 22 are connected to each other by being formed contiguously (integrally) with each other.

The pixel trunk portion 21 has a region formed as an island on the Cs bus line 12. Thus, the pixel trunk portion 21 comprises a portion formed as an island on the Cs bus line 12, and a portion formed along the top-down direction and/or the left-right direction.

The pixel branch portions 22 are portions formed as straight lines, in an oblique direction, in a subpixel opening, in a plan view of the substrates, i.e. viewed from the direction of the normal line of the substrate surface. The purpose of the pixel trunk portion 21 is to connect the plurality of pixel branch portions 22.

The common electrode 30 is formed from, for instance, a transparent conductive film such as ITO, or a metal film such as aluminum or the like, and has a comb shape in a plan view, within each subpixel. More specifically, the common electrode 30 has a common trunk portion 31 being a grid-like portion (trunk portion) disposed in the top-down direction and left-right direction, so as to planarly overlap the gate bus line 11 and the source bus line 13; and common branch portions 32 connected to the common trunk portion 31, the common branch portions 32 being portions (branch portions, comb teeth) having a linear shape in a plan view and being provided in a 45° or 315° direction.

The common trunk portion 31 and the common branch portions 32 are connected to each other by being formed contiguously (integrally) with each other.

The common trunk portion 31 is formed along the boundary line (top-down and left-right directions) between adjacent subpixels. The common trunk portion 31 is disposed on the gate bus line 11 and the source bus line 13 in such a way so as cover the gate bus line 11 and the source bus line 13. Thus, the common trunk portion 31 is disposed within the display area in such a way so as shield against the electric field generated by the gate bus line 11 and the source bus line 13.

The common branch portions 32 are portions formed as straight lines, in an oblique direction, in a subpixel opening, in a plan view of the substrates, i.e. viewed from the direction of the normal line of the substrate surface. The purpose of the common trunk portion 31 is to connect the plurality of common branch portions 32.

Thus, the pixel branch portions 22 and the common branch portions 32 have mutually complementary plan-view shapes, and are disposed alternately with a given spacing therebetween. Specifically, the pixel branch portions 22 and the common branch portions 32 are disposed to be mutually parallel, facing each other, within a same plane. In other words, the comb-shaped pixel electrode 20 and the comb-shaped common electrode 30 are oppositely disposed in such a manner that the comb teeth mesh with each other. The pixel electrode 20 and the common electrode 30 are disposed at a same layer. As a result, this allows forming a higher-density transverse electric field across the pixel electrode 20 and the common electrode 30, allows the liquid crystal layer 3 to be controlled with higher precision, and affords higher transmittance. The pixel electrode 20 and the common electrode 30 have a substantially symmetrical plan-view shape with respect to the centerline that traverses the center of the subpixel in the left-right direction.

The pixel trunk portion 21 corresponds to one of the first trunk portion and the second trunk portion, and the pixel branch portions 22 correspond to one of the first branch portion and the second branch portion.

The common trunk portion 31 corresponds to the other from among the first trunk portion and the second trunk portion, and the common branch portions 32 correspond to the other from among the first branch portion and the second branch portion.

In the liquid crystal display device of the present embodiment, application of an image signal (voltage) to the pixel electrode 20 via the TFT 14 causes an electric field (transverse electric field) to be generated between the pixel electrode 20 and the common electrode 30 in the surface direction of the substrates (active matrix substrate 1 and opposed substrate 2), such that the liquid crystal is driven by the transverse electric field, and the transmittance of each subpixel changes, to perform image display thereby.

In the liquid crystal display device of the present embodiment, more specifically, application of an electric field results in the formation of a distribution of electric field intensity within the liquid crystal layer 3. This distorts the alignment of the liquid crystal molecules, so that the retardation of the liquid crystal layer 3 is changed thereby. More specifically, the initial alignment state of the liquid crystal layer 3 is a homeotropic alignment, but a bend-like electric field is formed through generation of a transverse electric field in the liquid crystal layer 3 upon application of voltage to the comb-shaped pixel electrode 20 and the comb-shaped common electrode 30. As a result, two domains whose director direction is mutually dissimilar by 180° are formed between the electrodes 20 and 30, as illustrated in FIG. 2. In each domain (between electrodes), the liquid crystal molecules exhibit a bend-like liquid crystal array (bend alignment).

The liquid crystal molecules are aligned vertically at all times, regardless of the applied voltage value, at the region at which two domains are adjacent (ordinarily, on the centerline of the gap between the pixel electrode 20 and the common electrode 30). Therefore, a dark line forms at all times at this region (boundary), regardless of the applied voltage value.

The pixel branch portions 22 and the common branch portions 32 extend obliquely with respect to the boundary lines (top-down and left-right directions) between adjacent subpixels, in a plan view of both substrates. That is, the pixel branch portions 22 and the common branch portions 32 extend, from the pixel trunk portion 21 and the common trunk portion 31, in an oblique direction with respect to the extension direction of the pixel trunk portion 21 and of the common trunk portion 31, respectively.

Therefore, a blank portion (opening portion) of the pixel electrode 20 comprising an acute angle-shaped blank portion (acute angle blank portion) 23 and an obtuse angle-shaped blank portion (obtuse angle blank portion) 24 is formed in each subpixel. Also, a blank portion (opening portion) of the common electrode 30 comprising an acute angle-shaped blank portion (acute angle blank portion) 33 and an obtuse angle-shaped blank portion (obtuse angle blank portion) 34 is formed in each subpixel.

The acute angle blank portions 23, 33 are opening portions, of the electrodes 20, 30, that encompass an acute angle in a plan view of both substrates. The obtuse angle blank portions 24, 34 are opening portions, of the electrodes 20, 30, that encompass an obtuse angle in a plan view of both substrates.

The acute angle portion of the acute angle blank portions 23, 33 and the obtuse angle portion of the obtuse angle blank portions 24, 34 need not be strictly sharp, and may exhibit some rounding.

The magnitude of the acute angle formed by the pixel branch portions 22 and the common branch portions 32 with the boundary line between adjacent subpixels (ordinarily, the extension direction of the pixel trunk portion 21 and the common trunk portion 31) is not particularly limited, so long as the angle is not 90°. Preferably, the acute angle lies within a range of 45±2°, (more preferably a range of 45±1°. Transmittance may drop if the angle exceeds 45±2°.

The pixel branch portions 22 are enclosed by the common trunk portion 31, and one or two common branch portions 32 that are adjacent to the pixel branch portions 22. Some of the pixel branch portions 22 are disposed within the blank portion of the common electrode 30 that encompasses the mutually adjacent acute angle blank portion 33 and obtuse angle blank portion 34. These pixel branch portions 22 will be referred to hereafter as specific pixel branch portion 22a.

Likewise, the common branch portions 32 are surrounded by the pixel trunk portion 21 and one or two pixel branch portions 22 that are adjacent to the common branch portions 32. Some of the common branch portions 32 are disposed within the blank portion of the pixel electrode 20 that encompasses the mutually adjacent acute angle blank portion 23 and obtuse angle blank portion 24. These common branch portions 32 will be referred to hereafter as specific common branch portion 32a.

The specific pixel branch portion 22a corresponds to one from among the first specific branch portion and the second specific branch portion, and the specific common branch portion 32a corresponds to the other from among the first specific branch portion and the second specific branch portion.

As illustrated in FIG. 3, an acute angle-side spacing Sp,a denotes the spacing between the specific pixel branch portion 22a and the common electrode 30 (common trunk portion 31 or common branch portions 32, ordinarily the common branch portions 32), at a portion (portion adjacent to the acute angle blank portion 33) along the extension direction of the specific pixel branch portion 22a and that forms the acute angle blank portion 33. An obtuse angle-side spacing Sp,o denotes the spacing between the specific pixel branch portion 22a and the common electrode 30 (common trunk portion 31 or common branch portions 32, ordinarily the common branch portions 32) at a portion (portion adjacent to the obtuse angle blank portion 34) along the extension direction of the specific pixel branch portion 22a and that forms the obtuse angle blank portion 34.

The acute angle-side spacing Sp,a is set to be narrower than the obtuse angle-side spacing Sp,o, at least at the tip region of the specific pixel branch portion 22a.

That is, the tip region of the specific pixel branch portion 22a is disposed further towards the acute angle blank portion 33 than a centerline between portions (ordinarily, two common branch portions 32) that are adjacent to the specific pixel branch portion 22a in the transverse direction.

As a result, a potential difference (transverse electric field) sufficient for letting light through is generated, by the pixel electrode 20 and the common electrode 30, also at the acute angle blank portion 33.

The acute angle-side spacing Sp,a, more specifically, is the spacing in a direction perpendicular to the extension direction of the portion (ordinarily, the common branch portions 32) of the common electrode 30 that defines the acute angle-side spacing Sp,a. The obtuse angle-side spacing Sp,o, more specifically, is the spacing in a direction perpendicular to the extension direction of the common electrode 30 at a portion (ordinarily, the common branch portions 32) of the common electrode 30 that defines the obtuse angle-side spacing Sp,o.

The width of the tip region of the specific pixel branch portion 22a need not be set to be greater than at other regions, and hence there can be secured a region at which a transverse electric field is generated, also on the obtuse angle blank portion 34 side, so that drops in transmittance can be suppressed. The pixel branch portions 22 that encompass the specific pixel branch portion 22a do not become thicker from the root towards the tip, but extend at a substantially constant width, except at the endmost tip that is sharpened to a tapered (trapezoidal) shape.

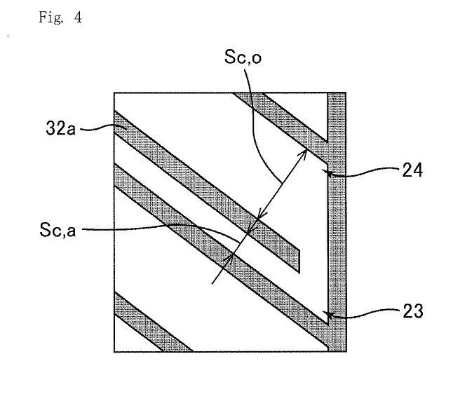

Likewise, as illustrated in FIG. 4, the acute angle-side spacing Sc,a is set to be narrower than the obtuse angle-side spacing Sc,o, at least at the tip region of the specific common branch portion 32a, wherein the acute angle-side spacing Sc,a denotes the spacing between the specific common branch portion 32a and the pixel electrode 20 (pixel trunk portion 21 or pixel branch portions 22, ordinarily the pixel branch portions 22) at a portion (portion adjacent to acute angle blank portion 23) along the extension direction of the specific common branch portion 32a and that forms the acute angle blank portion 23, and wherein the obtuse angle-side spacing Sc,o denotes the spacing between the specific common branch portion 32a and the pixel electrode 20 (pixel trunk portion 21 or pixel branch portions 22, ordinarily the pixel branch portions 22) at a portion (portion adjacent to the obtuse angle blank portion 24) along the extension direction of the specific common branch portion 32a and that forms the obtuse angle blank portion 24.

That is, the tip region of the specific common branch portion 32a is disposed further towards the acute angle blank portion 23 than a centerline between portions (ordinarily, two pixel branch portions 22) that are adjacent to the specific common branch portion 32a in the transverse direction.

As a result, a potential difference (transverse electric field) sufficient for letting light through is generated, by the pixel electrode 20 and the common electrode 30, also at the acute angle blank portion 23.

The acute angle-side spacing Sc,a, more specifically, is the spacing in a direction perpendicular to the extension direction of the portion (ordinarily, the pixel branch portion 20) of the pixel electrode 20 that defines the acute angle-side spacing Sc,a. The obtuse angle-side spacing Sc,o, more specifically, is the spacing in a direction perpendicular to the extension direction of the portion (ordinarily, the pixel branch portion 20) of the pixel electrode 20, that defines the obtuse angle-side spacing Sc,o.

The width of the tip region of the specific common branch portion 32a need not be set to be greater than at other regions, and hence there can be secured a region at which transverse electric field is generated, also on the obtuse angle blank portion 24 side, so that drops in transmittance can be suppressed. The common branch portions 32 that encompass the specific common branch portion 32a do not become thicker from the root towards the tip, but extend at a substantially constant width, except at the endmost tip that is sharpened to a tapered (trapezoidal) shape.

As a result, transmittance can be enhanced not only at the acute angle blank portion 33, but also at the acute angle blank portion 23, without making the pixel branch portions 22 and the common branch portions 32 thicker. The transmittance of the subpixel as a whole can be enhanced thereby.

In a case where that much transmittance need not be achieved, then just one from among the specific pixel branch portion 22a and the specific common branch portion 32a may be disposed on the side of a corresponding acute angle blank portion 33 or acute angle blank portion 23.

The root portion, more specifically, is a portion of the branch portion at which the latter is connected to the trunk portion.

The width of the portion of the pixel branch portions 22, excluding the endmost portion (i.e. the length, in the transverse direction, of the region of constant thickness) and the width of the portion of the common branch portions 32, excluding the endmost portion (i.e. the length, in the transverse direction, of the region of constant thickness), are all substantially identical at regions where the foregoing portions oppose each other.

In terms of increasing transmittance, the width of the pixel branch portions 22 and the common branch portions 32 is preferably as small as possible. In current process tools, the width is preferably set to range from about 1 to 4 μm (more preferably, from about 2.5 to 4.0 μm). Hereafter, the width of the pixel branch portions 22 and the common branch portions 32 will be referred to simply as line width L.

The plan-view shape of the tip of the pixel branch portions 22 is sharpened to a tapered (trapezoidal) shape, along the extension direction of the common trunk portion 31. Likewise, the plan-view shape of the tip of the common branch portions 32 is sharpened to a tapered (trapezoidal) shape, along the extension direction of the pixel trunk portion 21.

As a result, a transverse electric field is generated more effectively, and transmittance can be enhanced, between the pixel branch portions 22 and the common branch portions 32.

The specific pixel branch portion 22a is disposed on the side of the portion (common trunk portion 31 or common branch portions 32, ordinarily the common branch portions 32) of the common electrode 30 that forms the acute angle blank portion 33 , not only at the tip region, but also from the tip region to the root portion. That is, the adjacent acute angle-side spacing Sp,a and obtuse angle-side spacing Sp,o are set to be substantially constant from the tip region of the specific pixel branch portion 22a to the root portion of the specific pixel branch portion 22a.

As a result, it becomes possible to form effectively, within one subpixel, a region that comprises the acute angle-side spacing Sp,a and a region that comprises the obtuse angle-side spacing Sp,o. As described below, the phenomenon of floating white can be effectively reduced thereby.

Likewise, in the tip region as well as a region from the tip region up to the root portion the specific common branch portion 32a is disposed on the side of the portion (pixel trunk portion 21 or pixel branch portions 22, ordinarily the pixel branch portions 22) of the pixel electrode 20 that forms the acute angle blank portion 23. That is, the adjacent acute angle-side spacing Sc,a and the obtuse angle-side spacing Sc,o are set so as to be substantially constant from the tip region of the specific common branch portion 32a to the root portion of the specific common branch portion 32a.

As a result, it becomes possible to form effectively, within one subpixel, a region that comprises the acute angle-side spacing Sc,a and a region that comprises the obtuse angle-side spacing Sc,o. As described below, the phenomenon of floating white can be effectively reduced thereby.

The pixel branch portions 22 and the common branch portions 32 are disposed alternately with each other. Therefore, the acute angle-side spacing Sp,a is ordinarily equal to the acute angle-side spacing Sc,a, and the obtuse angle-side spacing Sp,o is ordinarily equal to the obtuse angle-side spacing Sc,o.

In the present embodiment, the spacing between the pixel electrode 20 and the common electrode 30 (more specifically, the spacing between pixel electrode 20 and the common electrode 30 (ordinarily, the pixel branch portions 22 and the common branch portions 32) in a direction perpendicular to the extension direction of the pixel branch portions 22 and the common branch portions 32; also reffered to hereinafter simply as electrode spacing) is set to either the acute angle-side spacing Sp,a (=acute angle-side spacing Sc,a) or the obtuse angle-side spacing Sp,o (=obtuse angle-side spacing Sc,o).

Accordingly, within each subpixel there is formed a region (narrow spacing region) of narrow electrode spacing comprising the acute angle-side spacing Sp,a (=acute angle-side spacing Sc,a), and a region (wide spacing region) of wide electrode spacing comprising the obtuse angle-side spacing Sp,o (=obtuse angle-side spacing Sc,o).

In the present embodiment, thus, the electrode branch portion (line) and the two electrode spacings (spaces), large and small, adjacent to the branch portion, constitute a set, such that a plurality of these sets is provided within each subpixel in such a manner that the region at which transmittance loss occurs is reduced, i.e. in such a manner that the blank portion of the common electrode 30 and the pixel electrode 20 including the acute angle blank portions 23, 33 is made smaller.

The electric field intensity is different between the narrow spacing region and the wide spacing region. Therefore, the V (voltage)-T (transmittance) characteristic in the narrow spacing region is different from the V-T characteristic in the wide spacing region. That is, the V-T characteristic of the liquid crystal display device of the present embodiment as a whole is a combination of at least two mutually dissimilar V-T characteristics. As described below, the occurrence of the floating white phenomenon can be effectively suppressed by setting the ratio (surface area of the narrow spacing region):(surface area of the wide spacing region) to range from 1:1 to 1:3. The occurrence of color tone changes can be also suppressed. That is, the viewing angle characteristic can be improved. Color tone changes happen as a result of changes of the V-T characteristic of the subpixels of each color depending on the polar angle.

The pixel electrode 20 and the common electrode 30 have two kinds of pixel branch portions 22 and common branch portions 32 whose extension directions are mutually perpendicular. In one subpixel there are formed, accordingly, two kinds of bend-like electric fields that are generated within the liquid crystal layer 3 and that have mutually perpendicular electric field directions. That is, two domains are formed in each kind of the pixel branch portions 22 and common branch portions 32. Therefore, a total of four domains become formed in one subpixel. As a result, this enables nonbiased viewing angle compensation in all orientations, up, down, left and right.

The various spacings are not particularly limited, but preferably the acute angle-side spacing Sp,a and the acute angle-side spacing Sc,a range from 2 to 6 μm (more preferably, from 3 to 5 μm). The effect of reducing the region of transmittance loss may weaken if the spacing exceeds 6 μm. On the other hand, the rate of occurrence of leak failure may increase if the spacing is smaller than 2 μm.

Preferably, the obtuse angle-side spacing Sp,o and the obtuse angle-side spacing Sc,o range from 7 to 12 μm (more preferably, from 8 to 10 μm). The shift amount of the V-T characteristic towards higher voltage may increase if the spacing exceeds 12 μm. The shift amount of the V-T characteristic towards lower voltage may increase if the spacing is smaller than 7 μm.

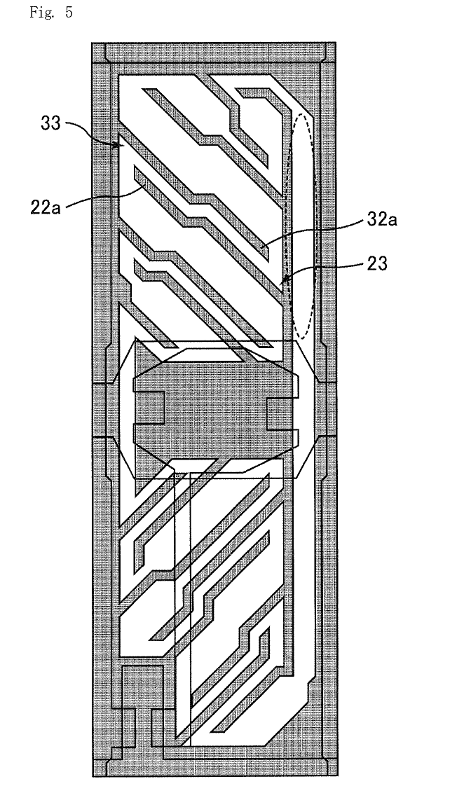

In the present embodiment, the pixel branch portions 22 and the common branch portions 32 may be shaped as straight lines, as illustrated in FIG. 1, or may be bent, as illustrated in FIG. 5. Thus, arranging the pixel branch portions 22 and/or common branch portions 32 in a bent manner allows at least the tip region of the specific pixel branch portion 22a and the specific common branch portion 32a, as described above, to be disposed on the side of the acute angle blank portions 23, 33, even in cases where it is difficult for the pixel branch portions 22 and/or the common branch portions 32 to have straight line shapes owing to constraints in subpixel size.

In the present embodiment, thus, the shape of the pixel branch portions 22 and the common branch portions 32 can be appropriately selected from among a straight line shape or a curved (bent) shape, depending on subpixel size. Transmittance loss can be minimized as a result.

In a case where one of the pixel branch portions 22 and the common branch portions 32 are bent, the other one of the pixel branch portions 22 and the common branch portions 32 is preferably also bent. As a result, the pixel branch portions 22 and the common branch portions 32 can be disposed facing each other parallelly in an easy manner.

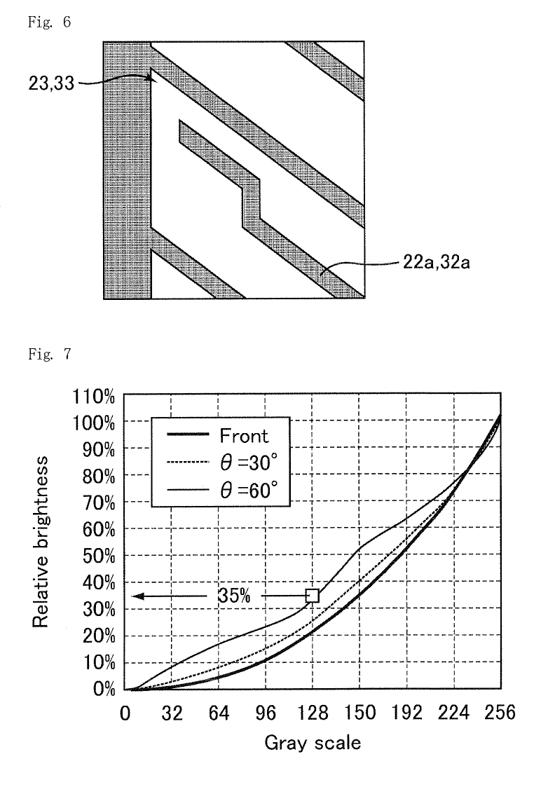

In terms of just suppressing loss of transmittance in the acute angle blank portion 33, the tip region alone of the specific pixel branch portion 22a may be disposed on the side of the portion at which the acute angle blank portion 33 is formed, as illustrated in FIG. 6.

In terms of just suppressing loss of transmittance in the acute angle blank portion 23, likewise, the tip region alone of the specific common branch portion 32a may be disposed on the side of the portion at which the acute angle blank portion 23 is formed, as illustrated in FIG. 6.

An explanation follows next, based on FIG. 7, on results obtained in a measurement of floating white characteristic, by simulation, in a case where a narrow spacing region and a wide spacing region are provided in one subpixel, as in the present embodiment. In FIG. 7 the electrode spacing in the narrow spacing region was set to 3 μm, and the electrode spacing in the wide spacing region was set to 10 μm. The line width L was set to 2.5 μm in both regions. The ratio (surface area of the narrow spacing region):(surface area of the wide spacing region) was set to 1:2.

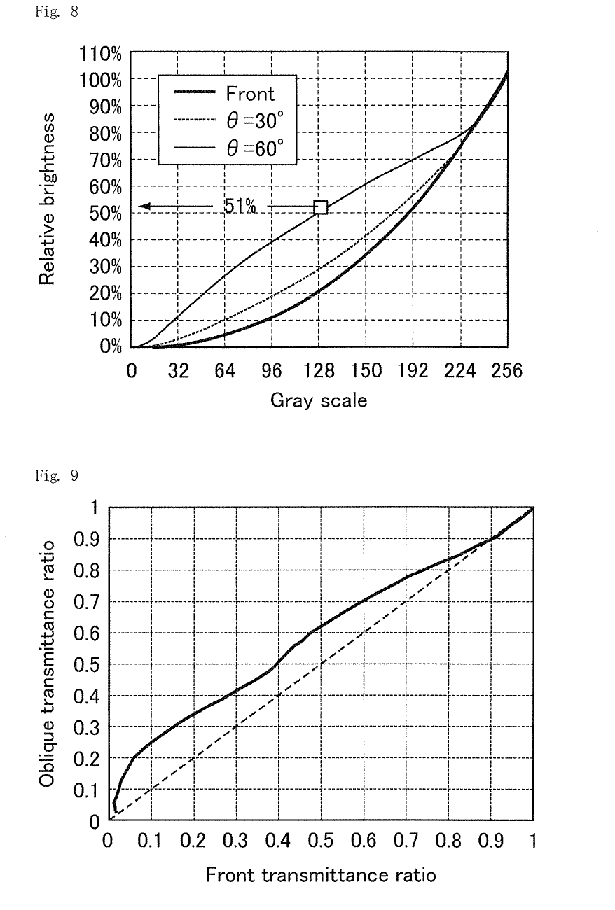

FIG. 8 illustrates the results of a measurement, by simulation, of floating white characteristic in a case where a single line width L and electrode spacing are set in one subpixel. In FIG. 8, the electrode spacing was set to 8 μm and the line width L was set to 2.5 μm.

FIGS. 7, 8 illustrate a y viewing angle characteristic viewed from a front direction, or a 3 o'clock direction (polar angle 30° or 60°) along the absorption axis direction of a polarizer. The relative brightness in the ordinate axis denotes the proportion (percentage) of the brightness at the time of a respective gray scale with respect to brightness at the time of highest gray scale.

Other simulation conditions common to FIGS. 7, 8 were as follows.

Pixel electrode: AC application (amplitude 0 to 6.5 V, frequency 30 Hz)

Herein, Vc (amplitude center) was set to the same potential as that of the common electrode.

Common electrode: DC 0 V applied

Δn: 0.1

d: 3.5 μm

Δε: 22

One negative C plate (retardation Re in the in-plane direction: 0 nm; retardation Rth in the normal direction: 270 nm) was disposed as an optical compensation plate outward of the rear substrate.

As a result, conspicuous floating white occurred in a configuration of single line width L and electrode spacing, in particular during gradation display, as illustrated in FIG. 8. Upon observation from a direction of polar angle 60° at a time of 128 gray scale, for instance, the relative brightness was 51%, which deviated significantly from the relative brightness (about 20%) in the front direction.

As illustrated in FIG. 7, by contrast, the occurrence of floating white could be effectively suppressed in the present embodiment having two regions of dissimilar electrode spacing within one subpixel. Upon observation from a direction of polar angle 60° at a time of 128 gray scale, for instance, the relative brightness was 35%, which was a comparatively close value to the relative brightness (about 20%) in the front direction.

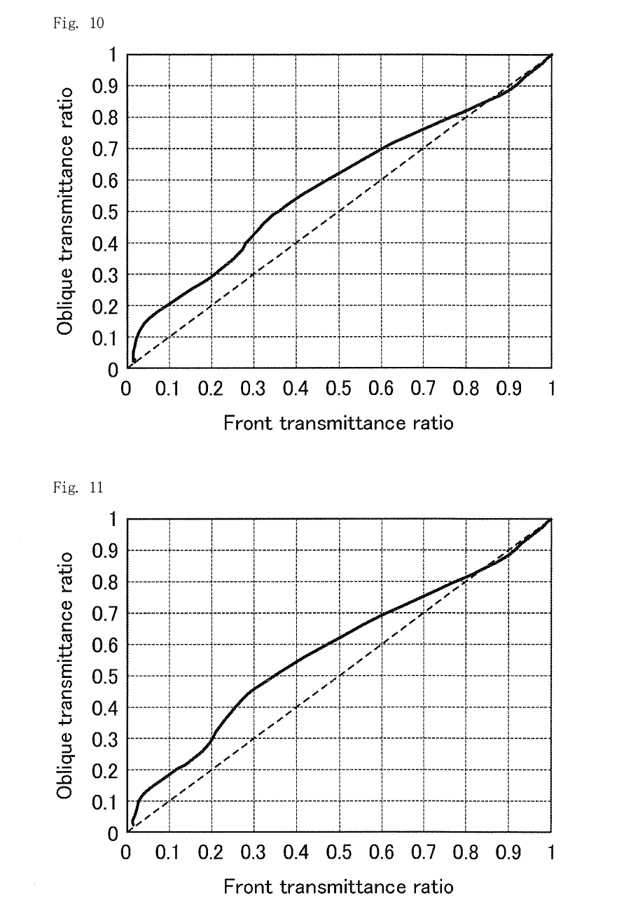

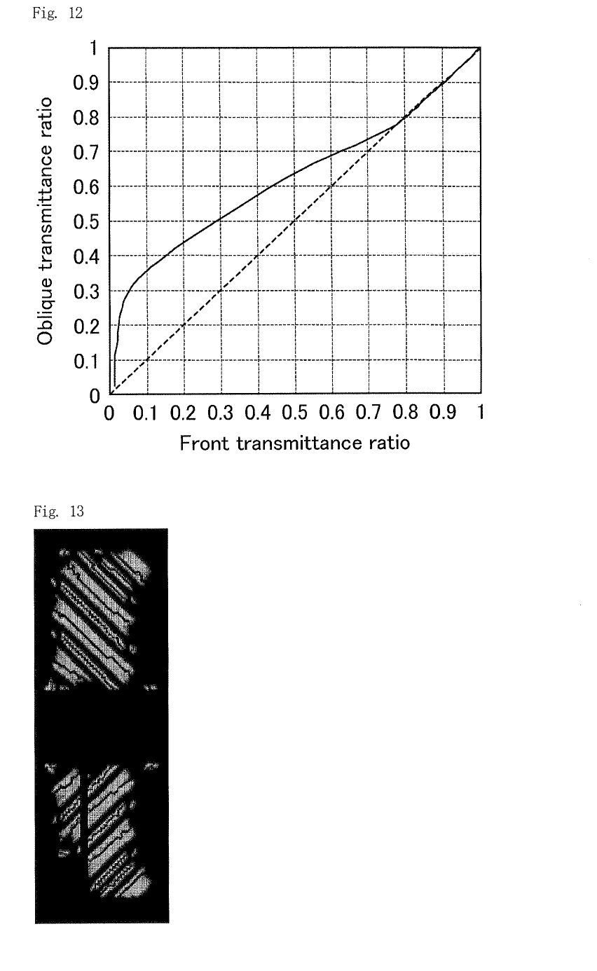

FIGS. 9 to 11 illustrate floating white characteristic upon changes in the surface area ratio between the narrow spacing region and the wide spacing region. In FIGS. 9 to 11, the electrode spacing in the narrow spacing region was set to 3 μm, and the electrode spacing in the wide spacing region was set to 10 μm. The line width L was set to 2.5 μm in both regions. In FIG. 9, the ratio (surface area of the narrow spacing region):(surface area of the wide spacing region) was set to 1:1. In FIG. 10, the ratio (surface area of the narrow spacing region):(surface area of the wide spacing region) was set to 1:2. In FIG. 11, the ratio (surface area of the narrow spacing region):(surface area of the wide spacing region) was set to 1:3.

FIG. 12 illustrates a floating white characteristic in a case where a single line width L and electrode spacing were set in one subpixel. In FIG. 12, the electrode spacing was set to 8 μm and the line width L was set to 2.5 μm.

Other simulation conditions common to FIGS. 9 to 12 were as follows.

Pixel electrode: AC application (amplitude 0 to 6.5 V, frequency 30 Hz)

Herein, Vc (amplitude center) was set to the same potential as that of the common electrode.

Common electrode: DC 0 V. applied

Δn: 0.1

d: 3.5 μm

Δε: 22

One negative C plate (retardation Re in the in-plane direction: 0 nm; retardation Rth in the normal direction: 270 nm) was disposed as an optical compensation plate outward of the rear substrate.

FIGS. 9 to 12 illustrate results of observation from a 3 o'clock direction (polar angle 60°). In the drawings, those regions where the front transmittance ratio (transmittance ratio in the front direction) range from about 0.2 to 0.3 correspond to a dark intermediate gray scale. Floating white is conspicuously noticeable upon display of this intermediate gray scale on the screen. Therefore, it is preferable that, around this gray scale region, the oblique transmittance ratio (ratio of transmittance as viewed from a 3 o'clock direction (polar angle 60°) with respect to the transmittance in the front direction) should match the front transmittance ratio. That is, the offset between the solid line and the dotted line in FIGS. 9 to 12 is preferably as small as possible at a region where the front transmittance ratio ranges from about 0.2 to 0.3.

It was found that, as a result, floating white was suppressed at a region corresponding to an intermediate gray scale, as illustrated in FIGS. 9 to 11, in the present embodiment having two regions of dissimilar electrode spacing within one subpixel. That is, the occurrence of the floating white phenomenon could be effectively supprPssed by setting the ratio (surface area of the narrow spacing region):(surface area of the wide spacing region) to range from 1:1 to 1:3.

By contrast, conspicuous floating white occurred at that region corresponding to the intermediate gray scale in a configuration of single line width L and electrode spacing, as illustrated in FIG. 12.

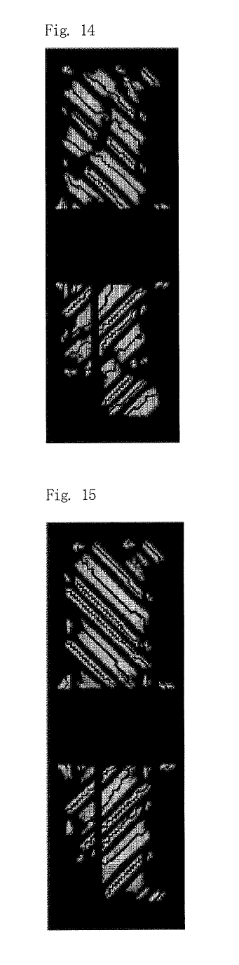

FIGS. 13 to 15 illustrate results of an optical simulation (alignment simulation) of the liquid crystal display device according to the embodiments. FIGS. 13 to 15 illustrate results for a potential of 6.5 V in the pixel electrode 20. FIGS. 13, 14 illustrate results according to the embodiments of FIGS. 1, 5, respectively. In the figures, the electrode spacing in the narrow spacing region was set to 3 μm, and the electrode spacing in the wide spacing region was set to 10 μm. The line width L was set to 2.5 μm in both regions. Further, the ratio (surface area of the narrow spacing region):(surface area of the wide spacing region) was set to 1:2.

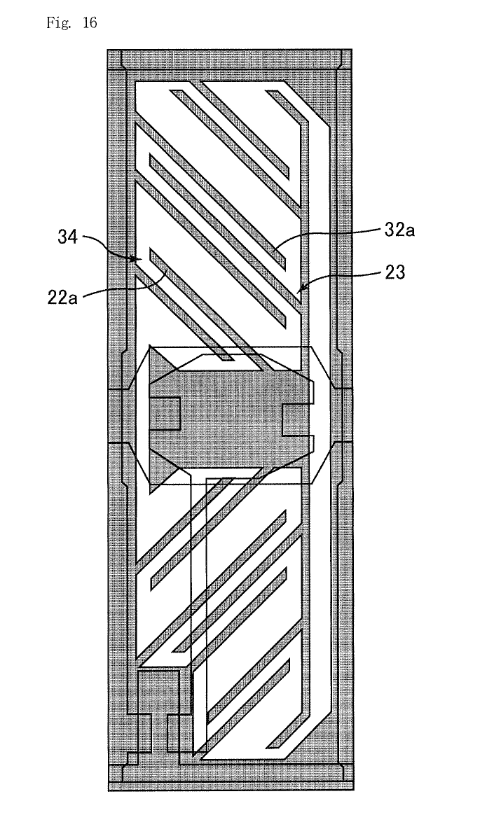

FIG. 15 illustrates results of an embodiment in which the specific common branch portion 32a is disposed on the acute angle blank portion 23 side, and some specific pixel branch portions 22a are disposed on the obtuse angle blank portion 34 side, as illustrated in FIG. 16. In the figures, the electrode spacing in the narrow spacing region was set to 3 μm, and the electrode spacing in the wide spacing region was set to 10 μm. The line width L was set to 2.5 μm in both regions. Further, the ratio (surface area of the narrow spacing region):(surface area of the wide spacing region) was set to 1:2.

Other simulation conditions common to FIGS. 13 to 15 were as follows.

Pixel electrode: AC application (amplitude 0 to 6.5 V, frequency 30 Hz)

Herein, Vc (amplitude center) was set to the same potential as that of the common electrode.

Common electrode: DC 0 V applied

Δn: 0.1

d: 3.5 μm

Δε: 22

One negative C plate (retardation Re in the in-plane direction: 0 nm; retardation Rth in the normal direction: 270 nm) was disposed as an optical compensation plate outward of the rear substrate.

The results of FIG. 13 show that the liquid crystal display device of the embodiment illustrated in FIG. 1 exhibited a transmittance of 6.9%. The results of FIG. 14 show that the liquid crystal display device of the embodiment illustrated in FIG. 5 exhibited a transmittance of 6.4%. The results of FIG. 15 show that the liquid crystal display device of the embodiment illustrated in FIG. 16 exhibited a transmittance of 6.1%. It was thus found that the liquid crystal display devices of the present embodiments succeeded in improving on the floating white phenomenon while minimizing transmittance loss. In terms of enhancing transmittance, it was found that, preferably, both the specific pixel branch portion 22a and the specific common branch portion 32a are arranged on the acute angle blank portion 33, 23 sides.

The present embodiment allows thus enhancing transmittance at the acute angle blank portion 23 and/or the acute angle blank portion 33. However, the electric field that is generated by the pixel trunk portion 21 and the common trunk portion 31 is oriented along the absorption axis direction of one of the linear polarizers at a region that is flanked by the pixel trunk portion 21 and the common trunk portion 31 (for instance, the region surrounded by the dotted-line ellipse in FIGS. 1, 5). In this region, specifically, the liquid crystal molecules are aligned along the absorption axis direction of one of the linear polarizers. This region, therefore, constitutes a region that does not let light through, even if there is sufficient potential difference (transverse electric field) so as to enable light transmission.

In the present embodiment, thus, transmittance loss may occur on account of the pixel trunk portion 21 and the common trunk portion 31. A second embodiment is described next of a configuration for suppressing transmittance loss caused by the pixel trunk portion 21 and the common trunk portion 31.

Embodiment 2

The liquid crystal display device of the present embodiment has the same configuration as that of Embodiment 1, except for differences in the subpixel layout. Accordingly, only differences with respect to Embodiment 1 will be explained in detail. In the explanation, members that fulfill the same functions as in Embodiment 1 are denoted with the same reference numerals as in Embodiment 1.

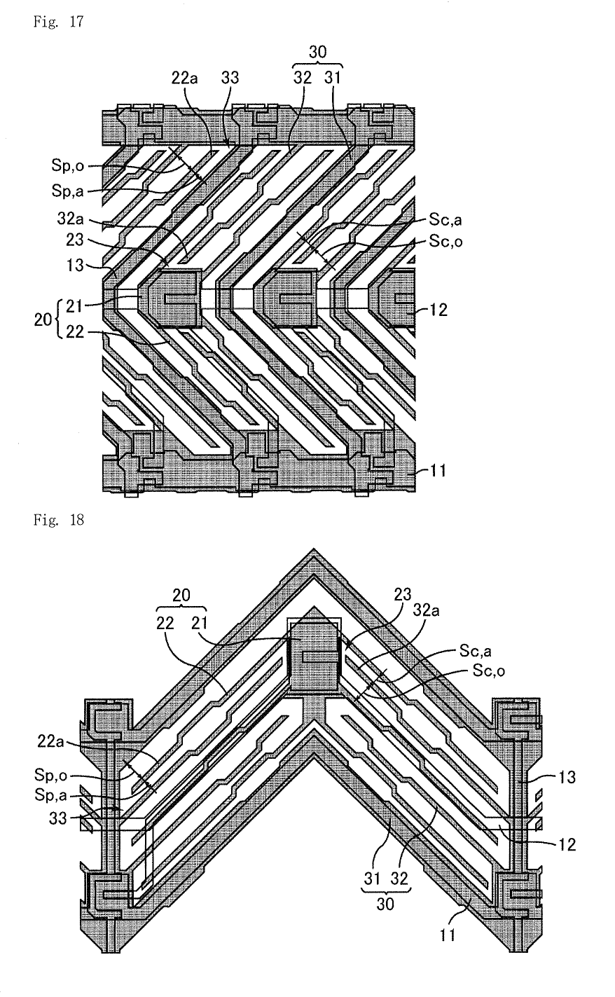

As illustrated in FIG. 17, the source bus line 13 in the present embodiment is bent in a V-like zigzag fashion, and the portions of the common electrode 30 on the source bus line 13 are likewise bent in a V-like zigzag fashion.

More specifically, the source bus line 13 has a plan-view shape in which there are coupled a portion extending in the 225° direction and a portion extending in the 315° direction. The gate bus line 11 and the Cs bus line 12 are formed linearly in the left-right direction.

The portion of the common trunk portion 31 that overlaps planarly with the source bus line 13 is bent, in a zigzag fashion, in the 225° direction and the 315° direction, in the same way as the source bus line 13.

The common branch portions 32 are connected to the portion of the common trunk portion 31 that overlaps planarly with the gate bus line 11. The common branch portions 32 extend from the top and bottom of the subpixel towards the center of the subpixel; more specifically, extend in a 135° direction or 225° direction from portions of the common trunk portion 31 that are positioned at the top and bottom of the subpixel.

The pixel trunk portion 21 is provided as an island in the center of the subpixel. The pixel branch portions 22 extend from the center of the subpixel towards the top and bottom of the subpixel, more specifically, extend from the pixel trunk portion 21 in a 45° direction or 315° direction.

In the present embodiment, the orientation of the electric field generated by the pixel branch portions 22 and by the portions of the common trunk portion 31 that planarly overlap the source bus line 13 runs along a direction at an angle of substantially 45° with respect to the absorption axis direction of the pair of linear polarizers. That is, the liquid crystal molecules are aligned obliquely with respect to the absorption axis direction of the pair of linear polarizers at the region between the pixel branch portions 22 and the portion of the common trunk portion 31 that overlaps planarly with the source bus line 13. As a result, light can be transmitted through the region.

Thus, the present embodiment allows effectively suppressing drops in transmittance caused by the pixel trunk portion 21 and the common trunk portion 31, as in Embodiment 1.

In the liquid crystal display device of the present embodiment it may be the gate bus line 11 and the Cs bus line 12 that are bent, instead of the source bus line 13.

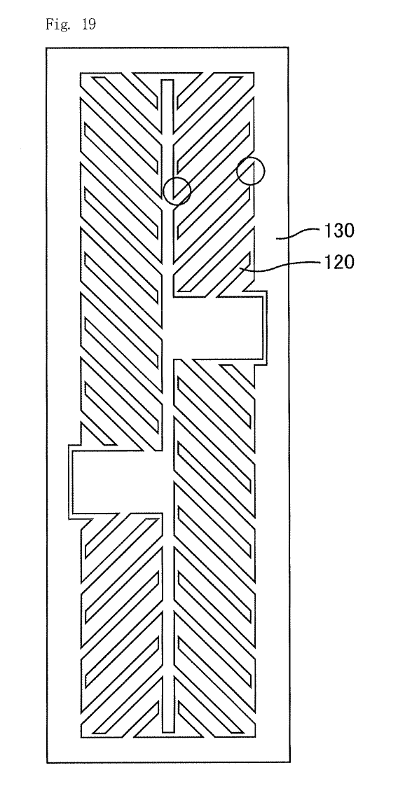

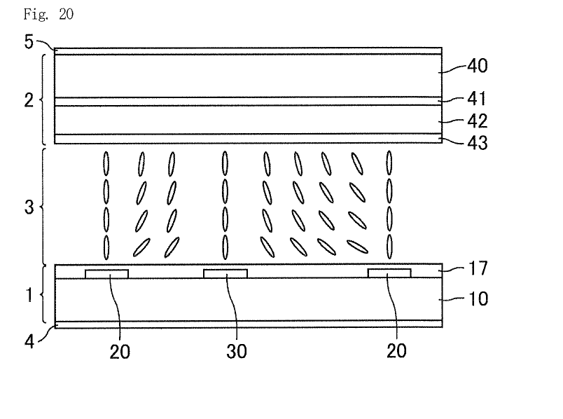

In the present embodiment, specifically, the gate bus line 11 and the Cs bus line 12 may be bent in a V-like zigzag fashion, as illustrated in FIG. 18, and the portions of the common electrode 30 over the source bus line 11 are likewise bent in a V-like zigzag fashion.

More specifically, the gate bus line 11 and the Cs bus line 12 have a plan-view shape such that a portion extending in the 45° direction is linked to a region extending in the 315° direction. The source bus line 13, by contrast, is formed linearly in the top-down direction.

The portion of the common trunk portion 31 that overlaps planarly with the gate bus line 11 is bent, in a zigzag fashion, in the 45° direction and the 315° direction, in the same way as the gate bus line 11.

The common branch portions 32 are connected to the portion of the common trunk portion 31 that overlaps planarly with the source bus line 13. The common branch portions 32 extend from the left and right of the subpixel towards the center of the subpixel; more specifically, extend in a 45° direction or 135° direction from portions of the common trunk portion 31 that are positioned at the left and right of the subpixel.

The pixel trunk portion 21 is provided as an island in the center of the subpixel. The pixel branch portions 22 extend from the center of the subpixel towards the left and right of the subpixel, more specifically, extend from the pixel trunk portion 21 in a 225° direction or 315° direction.

In this configuration, the orientation of the electric field generated by the pixel branch portions 22 and by the portions of the common trunk portion 31 that planarly overlap the gate bus line 11 runs along a direction at an angle of substantially 45° with respect to the absorption axis direction of the pair of linear polarizers. That is, the liquid crystal molecules are aligned obliquely with respect to the absorption axis direction of the pair of linear polarizers at the region between the pixel branch portions 22 and the portion of the common trunk portion 31 that overlaps planarly with the gate bus line 11. As a result, light can be transmitted through the region.

Thus, this configuration allows effectively suppressing drops in transmittance caused by the pixel trunk portion 21 and the common trunk portion 31, as in Embodiment 1.

In all the above configurations, needless to say, the tip region of the specific pixel branch portion 22a is disposed on the acute angle blank portion 33 side. The tip region of the specific common branch portion 32a is disposed on the acute angle blank portion 23 side.

The acute angle-side spacing Sp,a and the obtuse angle-side spacing Sp,o change stepwise from the tip region of the specific pixel branch portion 22a to the root portion of the specific pixel branch portion 22a.

More specifically, the magnitudes of the acute angle-side spacing Sp,a and the obtuse angle-side spacing Sp,o, i.e. the narrow spacing region and the wide spacing region, are swapped alternately from the tip region of the specific pixel branch portion 22a to the root portion of the specific pixel branch portion 22a while the sum total of the acute angle-side spacing Sp,a and the obtuse angle-side spacing Sp,o is kept constant

Likewise, the acute angle-side spacing Sc,a and the obtuse angle-side spacing Sc,o change stepwise from the tip region of the specific common branch portion 32a to the root portion of the specific common branch portion 32a.

More specifically, the magnitudes of the acute angle-side spacing Sc,a and the obtuse angle-side spacing Sc,o, i.e. the narrow spacing region and the wide spacing region, are swapped alternately from the tip region of the specific common branch portion 32a to the root portion of the specific common branch portion 32a, while the sum total of the acute angle-side spacing Sc,a and the obtuse angle-side spacing Sc,o is kept constant.

This configuration as well allows forming a plurality of regions of dissimilar electrode spacing within one subpixel. The floating white phenomenon can be effectively suppressed as a result.

Embodiment 3

The liquid crystal display device of the present embodiment differs from Embodiments 1 and 2 as regards the features below.

Specifically, the liquid crystal display device of the present embodiment has a counter electrode on the opposed substrate side. In more concrete terms, the opposed substrate 2 comprises a glass substrate 40, plus a counter electrode 41, a dielectric layer (insulating layer) 42 and a vertical alignment film 43 that are stacked, in this order, on the main surface of the glass substrate 40 on the liquid crystal layer 3 side. A BM layer and/or colored layer may be provided between the counter electrode 41 and the glass substrate 40.

The counter electrode 41 is formed of a transparent conductive film of ITO, IZO or the like. The counter electrode 41 and the dielectric layer 42 are formed without breaks so as to cover at least the entire display area. A predetermined potential shared by the subpixels is applied to the counter electrode 41.

The dielectric layer 42 is formed of a transparent insulating material. Specifically, the dielectric layer 42 is formed of an inorganic insulating film such as silicon nitride, or of an organic insulating film such as an acrylic resin or the like.

The active matrix substrate 1 comprises a glass substrate 10, and is provided with a pixel electrode 20, a common electrode 30 and a vertical alignment film 17, identical to those of Embodiments 1 and 2. Linear polarizers 4, 5 are provided on the outer main surface of the two substrates 1 and 2.

Other than during black display, dissimilar voltages are applied between the pixel electrode 20, and the common electrode 30 and the counter electrode 41. The common electrode 30 and the counter electrode 41 may be grounded. The voltages applied to the common electrode 30 and the counter electrode 41 may be of the same magnitude and polarity, or of dissimilar magnitude and polarity.

The liquid crystal display device of the present embodiment allows enhancing transmittance, as in Embodiment 1. Further, the response time can be enhanced by forming the counter electrode 41.

The present application claims priority to Patent Application No. 2009-129514 filed in Japan on May 28, 2009 and Patent Application No. 2010-6694 filed in Japan on Jan. 15, 2010 under the Paris Convention and provisions of national law in a designated State, the entire contents of which are hereby incorporated by reference.

### EXPLANATION OF REFERENCE NUMERALS

1: active matrix substrate (TFT array substrate)

2: opposed substrate

3: liquid crystal layer

4, 5: linear polarizer

10, 40: glass substrate

11: gate bus line

12: Cs bus line

13: source bus line

14: TFT

15: drain wiring

16: gate

17, 43: vertical alignment film

20, 120: pixel electrode

21: pixel trunk portion

22: pixel branch portion

22a: specific pixel branch portion

23, 33: acute angle blank portion

24, 34: obtuse angle blank portion

30, 130: common electrode

31: common trunk portion

32: common branch portion

32a: specific common branch portion

41: counter electrode

42: dielectric layer

Sp,a, Sc,a: acute angle-side spacing

Sp,o, Sc,o: obtuse angle-side spacing

1. A liquid crystal display device provided with a first substrate and a second substrate disposed opposing each other, and a liquid crystal layer sandwiched between the first substrate and the second substrate, wherein
the first substrate includes a comb-shaped first electrode and a comb-shaped second electrode;
the first electrode and the second electrode are disposed opposing each other planarly within a pixel;
the first electrode includes a first trunk portion, and a first branch portion that is connected to the first trunk portion and that intersects obliquely the first trunk portion;
the second electrode includes a second trunk portion, and a second branch portion that is connected to the second trunk portion and that intersects obliquely the second trunk portion;
the liquid crystal layer includes a p-type nematic liquid crystal and is driven by an electric field generated between the first electrode and the second electrode;
the p-type nematic liquid crystal is vertically aligned with respect to surfaces of the first substrate and of the second substrate when no voltage is applied;
the pixel includes a blank portion of the second electrode including an acute angle-shaped blank portion and an obtuse angle-shaped blank portion that are mutually adjacent, in a plan view of the surfaces of the first substrate and the second substrate;
the first branch portion includes a specific branch portion disposed within the blank portion of the second electrode, and wherein
an acute angle-side spacing, which is a spacing between the specific branch portion and a portion of the second electrode that extends along an extension direction of the specific branch portion and that forms the acute angle-shaped blank portion, is narrower, at least at a tip region of the specific branch portion, than an obtuse angle-side spacing, which is a spacing between the specific branch portion and a portion of the second electrode that extends along the extension direction of the specific branch portion and that forms the obtuse angle-shaped blank portion.

2. The liquid crystal display device according to claim 1, wherein the acute angle-side spacing and the obtuse angle-side spacing are constant from the tip region of the specific branch portion to a root portion of the specific branch portion.

3. The liquid crystal display device according to claim 1, wherein the acute angle-side spacing and the obtuse angle-side spacing change stepwise from the tip region of the specific branch portion to a root portion of the specific branch portion.

4. The liquid crystal display device according to claim 1, wherein the specific branch portion is linear-shaped.

5. The liquid crystal display device according to claim 1, wherein the specific branch portion is bent.

6. The liquid crystal display device according to claim 1, wherein the specific branch portion has a constant width.

7. The liquid crystal display device according to claim 1, wherein
the acute angle-shaped blank portion and the obtuse angle-shaped blank portion are a first acute angle-shaped blank portion and a first obtuse angle-shaped blank portion, respectively;
the specific branch portion is a first specific branch portion;
the acute angle-side spacing and the obtuse angle-side spacing are a first acute angle-side spacing and a first obtuse angle-side spacing, respectively;
the pixel includes a blank portion of the first electrode including a second acute angle-shaped blank portion and a second obtuse angle-shaped blank portion that are mutually adjacent, in a plan view of the surfaces of the first substrate and the second substrate;
the second branch portion includes a second specific branch portion disposed within the blank portion of the first electrode; and
a second acute angle-side spacing, which is a spacing between the second specific branch portion and a portion of the first electrode that extends along an extension direction of the second specific branch portion and that forms the second acute angle-shaped blank portion is narrower, at least at a tip region of the second specific branch portion, than a second obtuse angle-side spacing, which is a spacing between the second specific branch portion and a portion of the first electrode that extends along the extension direction of the second specific branch portion and that forms the second obtuse angle-shaped blank portion.

8. The liquid crystal display device according to claim 7, wherein the second acute angle-side spacing and the second obtuse angle-side spacing are constant from the tip region of the second specific branch portion to a root portion of the second specific branch portion.

9. The liquid crystal display device according to claim 7, wherein the second acute angle-side spacing and the second obtuse angle-side spacing change stepwise from the tip region of the second specific branch portion to a root portion of the second specific branch portion.

10. The liquid crystal display device according to claim 7, wherein the second specific branch portion is linear-shaped.

11. The liquid crystal display device according to claim 7, wherein the second specific branch portion is bent.

12. The liquid crystal display device according to claim 7, wherein the second specific branch portion has a constant width.

13. The liquid crystal display device according to claim 1, wherein the first trunk portion includes a portion along a top-down or left-right direction.

14. The liquid crystal display device according to claim 1, wherein the second trunk portion includes a portion along a top-down or left-right direction.

15. The liquid crystal display device according to claim 1, wherein the first substrate includes a gate bus line bent in the form of a V within a display area.

16. The liquid crystal display device according to claim 1, wherein the first substrate includes a source bus line bent in the form of a V within a display area.

17. The liquid crystal display device according to claim 1, wherein
the liquid crystal display device includes, within the pixel, two regions having mutually dissimilar electrode spacings, which are spacings between the first electrode and the second electrode, and
a ratio (surface area of a region of narrower electrode spacing, from among the two regions):(surface area of a region of wider electrode spacing, from among the two regions) ranges from 1:1 to 1:3.
